(19) United States
(12) Patent Application Publication
(10) Pub. No.: US 2015/0348585 A1
(43) Pub. Date: Dec. 3, 2015

(54) AUDIO EDITING AND RE-RECORDING

(71) Applicant: APPLE INC., Cupertino, CA (US)

(72) Inventors: Charles John Pisula, Bethesda, MD (US); Charles Magahern, San Francisco, CA (US); Jonathan Robert Dascola, San Francisco, CA (US); Edward Thomas Schmidt, Burlingame, CA (US); Elizabeth Caroline Cranfill, Cupertino, CA (US)

(73) Assignee: APPLE INC., Cupertino, CA (US)

(21) Appl. No.: 14/292,663

(22) Filed: May 30, 2014

(51) Int. Cl. G11B 20/10; G06F 17/30

(52) U.S. Cl. CPC G11B 20/10527; G06F 17/3074; G11B 2020/10546

(57) ABSTRACT

Instructions stored in a tangible, non-transitory, computer-readable medium executable by a computing device to record audio. The instructions include instructions to, when a first record command to record a first piece of audio is detected, generate an original audio composition, which includes a first audio file reference to a first audio file that stores a digital representation of the first piece of audio, a first waveform file reference to a first waveform file that stores a digital representation of intensity of the first piece of audio, and a first metadata. Additionally, the instructions includes instructions to, when a second record command that modifies at least a portion of the first piece of audio is detected, generate an audio fragment, which includes a second audio file reference to a second audio file that stores a digital representation of the second piece of audio, a second waveform file reference to a second waveform file that stores a digital representation of intensity of the second piece of audio, and a second metadata. More specifically, the first metadata and second metadata describe playback organization of the first audio file, the second audio file, the first waveform file, and the second waveform file, and enable recomposition of the original audio composition and the audio fragment into a composed audio composition.

### BACKGROUND

The present disclosure relates generally to audio recording, and more particularly, to editing recorded audio.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Generally, a computing device may record pieces of audio for later play back. More specifically, to enable play back, a digital representation of the recorded audio may be saved as a single audio file. Additionally, it is often desirable to edit (e.g., modify) portions of the recorded audio. For example, a user may edit a recorded piece of audio by inserting an additional piece of audio, removing portions of the recorded audio, and the like. In some embodiments, to edit the recorded audio, the audio file may be modified. However, even with advancements in processing power, modifying the audio file may take a noticeable amount of time, for example, anywhere from 10-90 seconds

Accordingly, it would be beneficial to improve efficiency of the audio recording process, for example, by reducing the amount of time used to process edits on recorded audio.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure generally relates to improving an audio editing process by improving the efficiency that edits to recorded audio are processed. Generally, when an original piece of audio is recorded, an original audio composition may be created, which includes an audio file reference to an audio file that stores a digital representation of the original audio, a waveform file reference to an waveform file that stores a digital representation of the intensity of the original audio, and metadata. When portions of the original audio are modified by re-recording additional pieces of audio over portions of the original audio, audio fragments may be created. Generally, the audio fragment may also include an audio file reference, a waveform file reference, and metadata. Additionally, in some embodiments, when audio fragments are created, the audio file and/or waveform file referenced in the original audio composition are not modified.

In some embodiments, the metadata in the original audio composition and the metadata in audio fragments may include a source time range and a destination time range. More specifically, the source time range may describe a portion of the recorded audio to use in playback and the destination time range may describe a playback relationship between the original audio composition audio file, any audio fragment audio files, the original audio composition waveform file, and any audio fragment waveform files. In other words, playback may be enabled by adjusting the metadata in the original audio composition and any audio fragments.

More specifically, creating audio fragment improves a re-recording (e.g., overwrite or replace) process because such edits may be processed without modifying the audio files. For example, an original audio composition may be created by a computing device when a first piece of audio is recorded. After the first piece of audio is recorded, a second piece of audio may be recorded to overwrite a portion of the first piece of audio. To perform the overwrite edit, an audio fragment may be created such that the destination time range instructs the computing device to playback the second audio instead of the overwritten portion of the first piece of audio.

Additionally, using audio fragments may improve trimming and deleting processes because such edits may be processed by merely adjusting metadata (e.g., source time range and/or destination time range). For example, a recorded piece of audio may be trimmed (e.g., unselected portion may be deleted) by shortening the source time range to a selected length. Furthermore, using audio fragments may enable undoing operations because the edits operations may be performed by adjusting the metadata (e.g., source time range and/or destination time range) and, in some embodiments, even without modifying the audio files or waveform files themselves. Moreover, when the edits are finalized, the original audio composition and any audio fragments may be recomposed into a composed audio composition based at least in part on the metadata (e.g., source time range and/or destination time range).

### BRIEF DESCRIPTION OF THE DRAWINGS

Various aspects of this disclosure may be better understood upon reading the following detailed description and upon reference to the drawings in which:

FIG. 1 is a block diagram of a computing device used to make an audio recording, in accordance with an embodiment;

FIG. 2 is an example of the computing device of FIG. 1, in accordance with an embodiment;

FIG. 3A is a graphical user interface displayed on the computing device of FIG. 1 before beginning an audio recording, in accordance with an embodiment;

FIG. 3B is a graphical user interface displayed on the computing device of FIG. 1 when the audio recording is paused, in accordance with an embodiment;

FIG. 3C is a graphical user interface displayed on the computing device of FIG. 1 after the audio recording is complete, in accordance with an embodiment;

FIG. 4A is a graphical user interface displayed on the computing device of FIG. 1 before a portion of the audio recording is overwritten, in accordance with an embodiment;

FIG. 4B is a graphical user interface displayed on the computing device of FIG. 1 after the portion of the audio recording is overwritten, in accordance with an embodiment;

FIG. 5A is a graphical user interface displayed on the computing device of FIG. 1 with a portion of the audio recording selected, in accordance with an embodiment;

FIG. 5B is a graphical user interface displayed on the computing device of FIG. 1 with the selected portion of the audio recording replaced, in accordance with an embodiment;

FIG. 6 is a flow diagram of a process for re-recording a portion of recorded audio, in accordance with an embodiment;

FIG. 7 is a block diagram of playing back recorded audio using a composed audio composition, in accordance with an embodiment;

FIG. 8 is a flow diagram of a process for trimming/deleting a selected portion of recorded audio, in accordance with an embodiment;

FIG. 9 is a flow diagram of a process for undoing an edit operation, in accordance with an embodiment; and

FIG. 10 is a flow diagram of a process for handling an unexpected closure of a recording application, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As mentioned above, a computing device may record audio to enable later play back. Additionally, the recorded audio may be edited to modify play back. More specifically, a portion of the recording may be re-recorded (e.g., overwritten, replaced, or shifted), removed (e.g., trimmed or deleted), and the like.

For example, a first piece of audio, which is one hour in duration, may be recorded. Subsequently, the portion of the recorded audio between the thirtieth minute and the fortieth minute may be recorded over (e.g., re-recorded) by a second piece of audio. Then, the portion of the recorded audio between the tenth minute and the sixtieth minute may be shifted over such that a third piece of audio, which is twenty minutes in duration, may be inserted into the recorded audio. As such, the total length of the recorded audio is eighty minutes. Additionally, during playback of the recorded audio, the beginning to the tenth minute of the first piece of audio may be played, followed by the beginning to twentieth minute of the third piece of audio, followed by the tenth to thirtieth minute of the first piece of audio, followed by the beginning to tenth minute of the second piece of audio, and followed by the fortieth to the sixtieth minute of the first piece of audio.

In some embodiments, to enable such editing to be performed on recorded audio, an existing audio file that stored a digital representation of the audio is modified each time the recorded audio is edited. For example, continuing with the above example, an audio file may be created when the first piece of audio is recorded. Then, when the second piece of audio is recorded, the audio file may be modified to reflect that a portion of the recorded audio is overwritten with the second piece of audio. Similarly, when the third piece of audio is recorded, the audio file may again be modified to reflect that a portion of the recorded audio is shifted down and the third piece of audio inserted.

However, the amount of time that is required to modify an audio file noticeably increases as the duration of the recorded audio increases. To help give perspective, take for example an audio file that stores a digital representation of an hour (e.g., sixty minute) long piece of recorded audio. Using an iPhone 5, available from Apple Inc. of Cupertino, Calif., modifying the audio file may take up to 60-90 seconds. Even with the increase processing power of an iPhone 5s, available from Apple Inc., modifying of the audio file may take up to 10-30 seconds. In other words, even using an iPhone 5, overwriting the recorded audio with the second piece of audio may take 10-30 seconds and shifting the recorded audio to insert the third piece of audio may take another 10-30 seconds. Thus, just processing those two edits may take between 20-60 seconds and may continue to increase as additional edits are performed. As such, it would be beneficial to improve the efficiency of editing recorded audio, for example, by reducing the time used to process each edit operation.

Accordingly, one embodiment described herein provides a tangible, non-transitory, computer readable medium that stores instructions executable by a processor of a computing device (e.g., an iPhone) that records audio. More specifically, the instructions may include instructions to, when a first record command to record a first piece of audio is detected, generate, an original audio composition that includes a first audio file reference to a first audio file, which stores a digital representation of the first piece of audio, a first waveform file reference to a first waveform file, which stores a digital representation of intensity of the first piece of audio, and a first metadata. Additionally, the instructions may include instructions to, when a second record command that modifies at least a portion of the first piece of audio is detected, generate an audio fragment that includes a second audio file reference to a second audio file, which stores a digital representation of the second piece of audio, a second waveform file reference to a second waveform file, which stores a digital representation of intensity of the second piece of audio, and a second metadata. In other words, an original composition may be generated when an original piece of audio is recorded and an audio fragment may be generated when the recorded audio is modified by re-recording. Depending on the edit operation, additional audio fragments may also be created with subsequent modifications to the recorded audio.

More specifically, the first metadata and second metadata may be used to describe playback organization of the first audio file, the second audio file, the first waveform file, and the second waveform file. In some embodiments, the first and second metadata may include a source time range, which describes what portion of the corresponding (e.g., referenced) audio file to use in playback, and a destination time range, which describes when to play the portion of the corresponding (e.g., referenced) audio file during playback. Thus, as will be described in more detail below, playback of the recorded audio (e.g., the first piece of audio with a portion modified by the second piece of audio) may be enabled merely by adjusting the first and second metadata. In other words, the first and second metadata is intended to be distinct from metadata that may be included in the audio files and/or waveform files.

Furthermore, the first and second metadata may be used for recomposition of the original audio composition and the audio fragment into a composed audio composition. In some embodiments, the composed audio composition may be generated after each edit operation is performed. Moreover, when all desired edits are performed on an audio recording, the composed audio composition (e.g., original audio composition with any audio fragments) may be used to generate a finalized audio file and/or a finalized waveform file. For example, when a user selects a done command, a finalized audio file may be generated by combining (e.g., stitching together) the audio file referenced in the original audio composition and the audio files referenced in one or more audio fragments. In other words, the audio files may be modified a single time at the end of the editing process. As such, the use of audio fragments may improve the efficiency of processing edits on recorded audio because the number of times the audio files are modified, which may take anywhere from 10-90 seconds, during the editing process may be reduced.

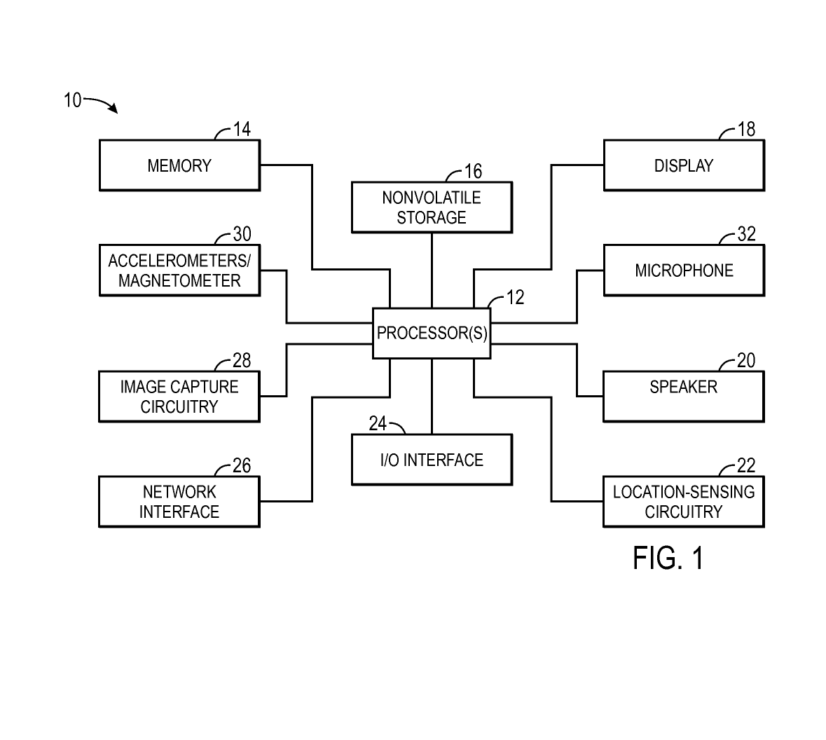

To help illustrate, a computing device 10 that may be used to record audio is described in FIG. 1. As depicted, the computing device generally includes one or more processor(s) 12, memory 14, non-volatile storage 16, a display 18, speakers 20, location-sensing circuitry 22, input/output (I/O) interface(s) 24, network interface(s) 26, image capture circuitry 28, accelerometer/magnetometer 30, and a microphone 32. The various functional blocks shown in FIG. 1 may include hardware elements (including circuitry), software elements (including computer code stored on a computer-readable medium) or a combination of both hardware and software elements. It should further be noted that FIG. 1 is merely one example of a particular implementation and is intended to illustrate the types of components that may be present in computing device 10.

As depicted the processor 12 is operably coupled with memory 14 and nonvolatile memory 16. More specifically, the processor 12 may execute instructions stored in memory 14 and/or nonvolatile memory 16 to perform various algorithms used in the presently described techniques. As such, the processor 12 may include one or more general purpose microprocessors, one or more application specific processors (ASICs), one or more field programmable logic arrays (FPGAs), or any combination thereof. Additionally, the memory 14 and/or the non-volatile memory 16 may be a tangible, non-transitory computer-readable medium that stores instructions executable by the processor 12 and/or data processed by the processor 12. For example, in some embodiments, the memory 14 may include random access memory (RAM) and the non-volatile memory 16 may include read only memory (ROM), flash memory, ferroelectric RAM (F-RAM), hard disks, floppy disks, magnetic tape, optical discs, or any combination thereof.

Thus, the processor 12 may utilize the other components in the computing device 10 to perform various functions. One function may include the communication of information with a user, which may include providing information to a user and receiving control commands from the user. To facilitate providing information, the processor 12 may provide audio data to the speakers 20 and instruct the speakers 20 to communicate the audio data to a user as sound. For example, the audio output by the speakers 20 may be an alarm to alert a user. In other embodiments, the audio output by the speakers 20 may be a piece of recorded audio.

Additionally, the processor 12 may provide video data to the display 18 and instruct the display 18 to display a graphical user interface that presents information to the user. For example, as will be described in more detail below, the graphical user interface displayed may be an audio recording screen that presents information related to an audio recording, such as the duration of the audio recording and intensity of the audio recording. In some embodiments, the display 18 may be integral to the computing device 10.

In other embodiments, one or more external displays may additionally or alternatively be used to provide information to the user. More specifically, one or more external displays may be communicatively coupled to the computing device 10 via the I/O interfaces 24. As such, the I/O interfaces 24 may include one or more video graphics array (VGA) ports, high definition multimedia interface (HDMI) ports, digital visual interface (DVI) ports, Thunderbolt ports, universal serial bus (USB) ports, or the like.

In other words, more generally, the I/O interfaces 24 may enable communication between the computing device 10 and directly connected external devices. As such, the I/O interfaces 24 may also facilitate receiving control commands from the user. More specifically, the I/O interfaces 24 may communicatively couple the computing device 10 to input devices such as, an external keyboard or an external microphone. Additionally, the display 18 may include touch-sensitive components that enable a user to input control commands by touching the display 18. For example, in the audio recording graphical user interface, a user may select a portion of an audio recording by touching the display 18 to set sliders.

Additionally, information may be communicated with remote users and/or remote devices via the network interface 26. More specifically, the network interface 26 may enable the computing device 10 to connect to a network, such as a personal area network (e.g., a Bluetooth network), a local area network (e.g., 802.11x Wi-Fi network), and/or for a wide area network (e.g., a 3G cellular network). For example, the computing device 10 may be communicatively coupled to a wireless microphone or wireless speakers via a Bluetooth network.

Another function the computing device 10 may perform is gathering information related to itself, such as its location or orientation. For example, the processor 12 may instruct the location-sensing circuitry 22 to determine the relative or absolute location of computing device 10. In some embodiments, the location-sensing circuitry 22 may include Global Positioning System (GPS) circuitry, algorithms for estimating location based on proximate wireless networks, such as local Wi-Fi networks, and so forth. Additionally, the processor 12 may instruct the accelerometers/magnetometer 30 to determine movement of the computing device and/or relative orientation of the computing device 10.

In addition to gather information related to itself, the computing device 10 may gather information related to its surroundings. For example, the processor 12 may instruct image capture circuitry 28 (e.g., camera) to capture an image of a feature (e.g., an object or surface) proximate to the image capture circuitry 28. Additionally, the processor 12 may instruct a microphone 32 to capture surrounding sounds, such as a user's voice. More specifically, a digital representation of the audio captured by the microphone 32 may be stored in memory 14 or non-volatile storage 16. In some embodiments, the microphone 32 may be integral to the computing device 10. Additionally or alternatively, an external microphone 32 may be used, for example, connected via the I/O interface 24 or the network interface 26.

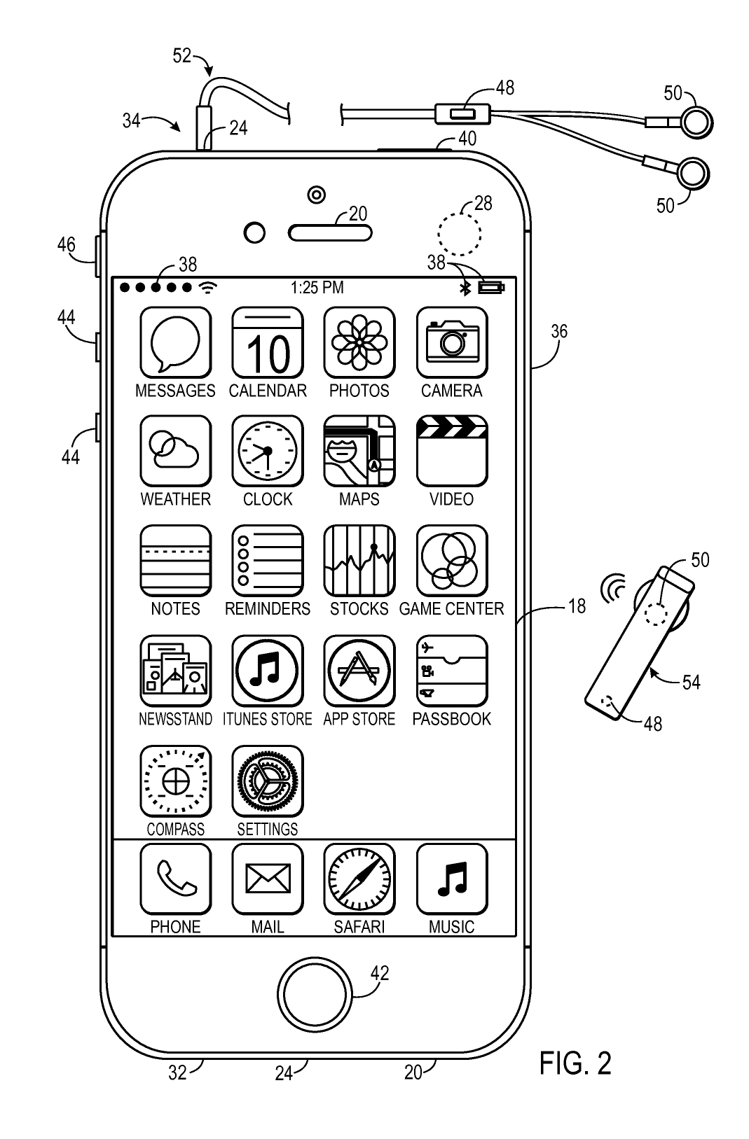

Based on the above description, the computing device 10 may be any electronic device suitable for capturing audio. For example, in some embodiments, the computing device 10 may be a computer, such as a MacBook®, MacBook® Pro, MacBook Air®, iMac®, Mac® mini, or Mac Pro® available from Apple Inc. In other embodiment, the computing device 10 may be a handheld device, such as the handheld device 34 described in FIG. 2. More specifically, the handheld device 34 may be an iPod® or iPhone® available from Apple Inc.

As depicted, the handheld device 34 includes an enclosure 36 to protect interior components from physical damage and to shield them from electromagnetic interference. The enclosure 36 may surround the display 18, which may display indicator icons 38. The indicator icons 38 may indicate cellular signal strength, Bluetooth connectivity, and/or battery life. Additionally, an I/O interface 24, such as a Lightning port from Apple Inc., may open through the enclosure 36 to enable the handheld device 34 to connect to external devices. Furthermore, as indicated in FIG. 2, the image capture circuitry 28 may open through the enclosure 36 on the revere side of the handheld device 34.

Additionally, as depicted, input structures 40, 42, 44, and 46 (e.g., integral input devices) open through the enclosure 36. More specifically, the input structures 40, 42, 44, and 46, in combination with a touch-sensitive display 18, may enable a user to input control command for controlling the handheld device 34. For example, input structure 40 may activate or deactivate the handheld device 34 and input structure 42 may navigate the graphical user interface to a home screen, a user-configurable application screen, and/or activate a voice-recognition feature of the handheld device 34. Additionally, input structures 44 may provide volume control and the input structure 46 may toggle between vibrate and ring modes.

Furthermore, as depicted, an integral microphone 32 and one or more integral speakers 20 open through the enclosure 36. In addition to using the integral microphone 32 and the integral speakers 20, the handheld device 34 may utilize external microphones and speakers. For example, in the depicted embodiment, an external microphone 48 and external speakers 50 are connected to the handheld device 34 via a wired headset 52. Additionally, in the depicted embodiment, an external microphone 48 and an external speaker 50 are connected to the handheld device 34 via a wireless headset 54. In some embodiments, the wireless headset 54 may be a Bluetooth headset. In other embodiments, the external microphone 48 may be a standalone microphone (not depicted) and the external speakers 50 may be standalone speakers (not depicted).

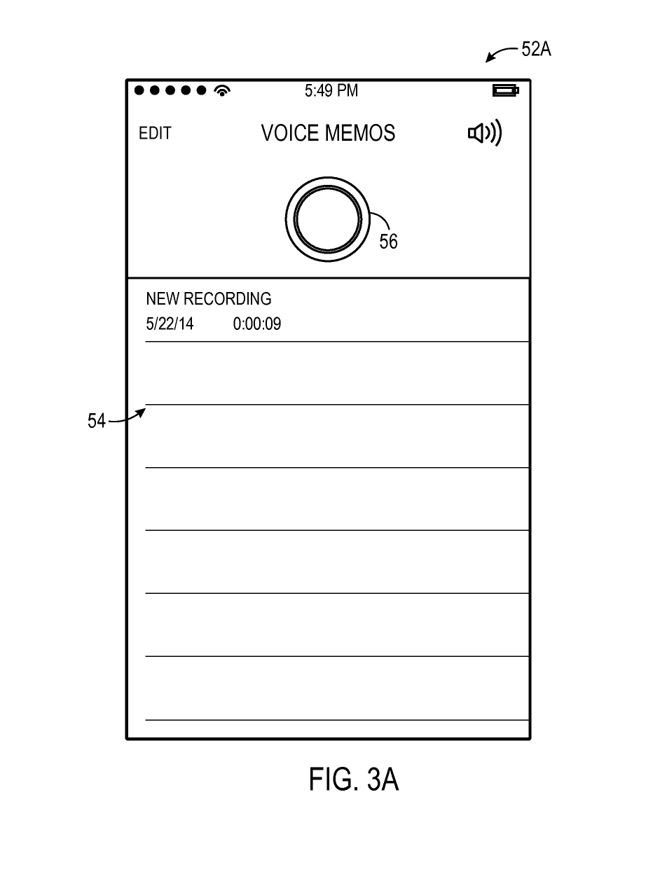

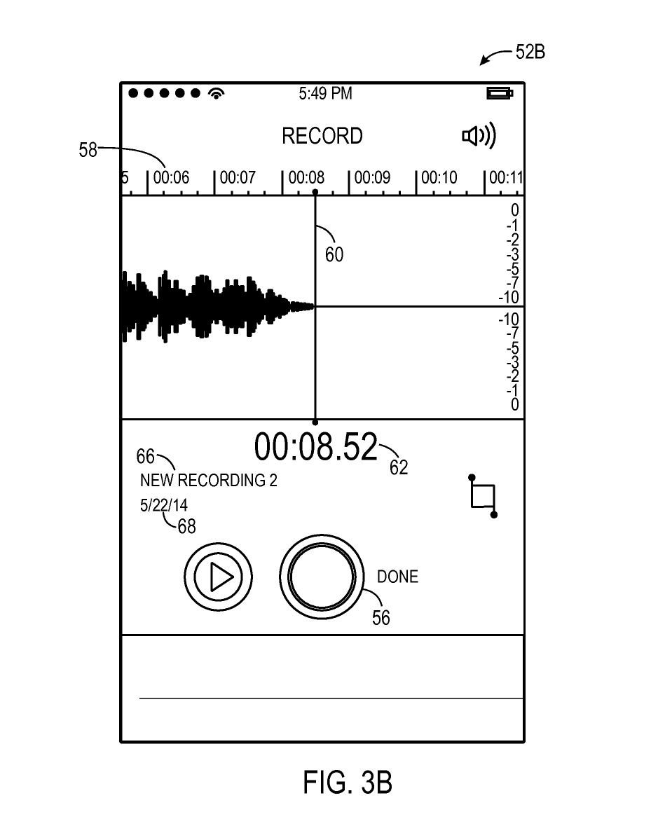

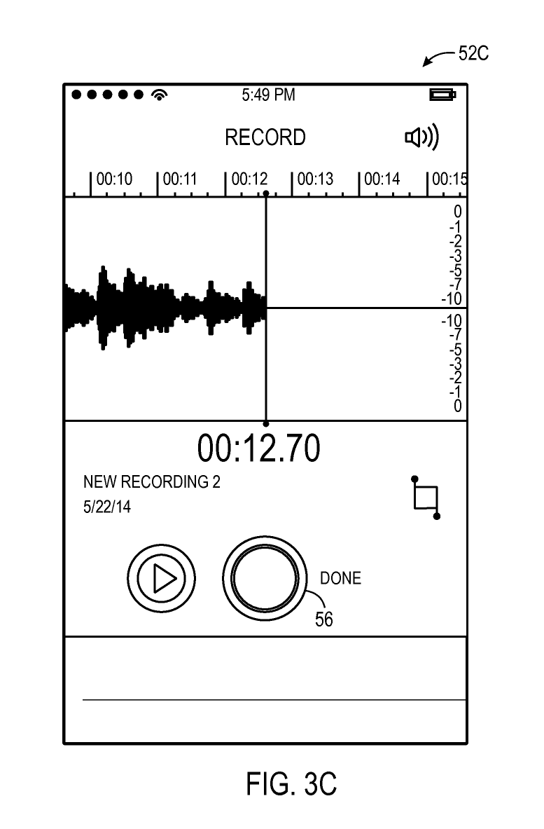

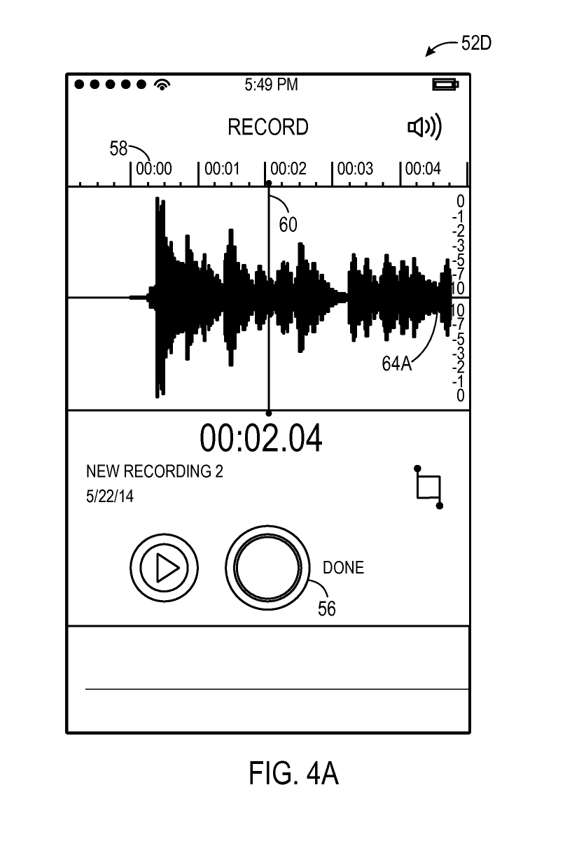

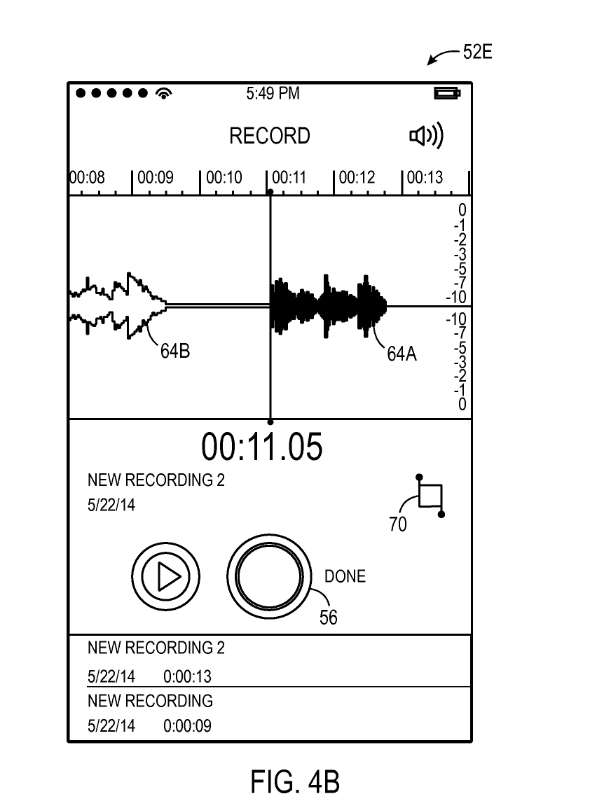

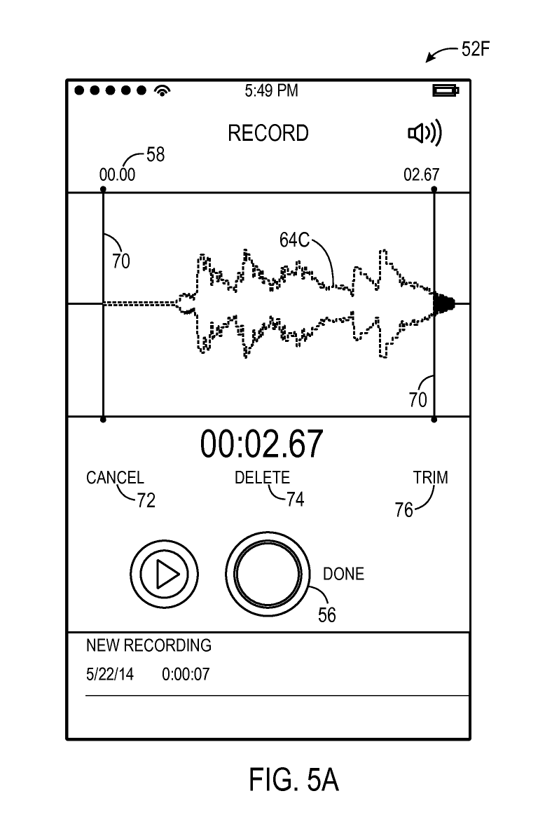

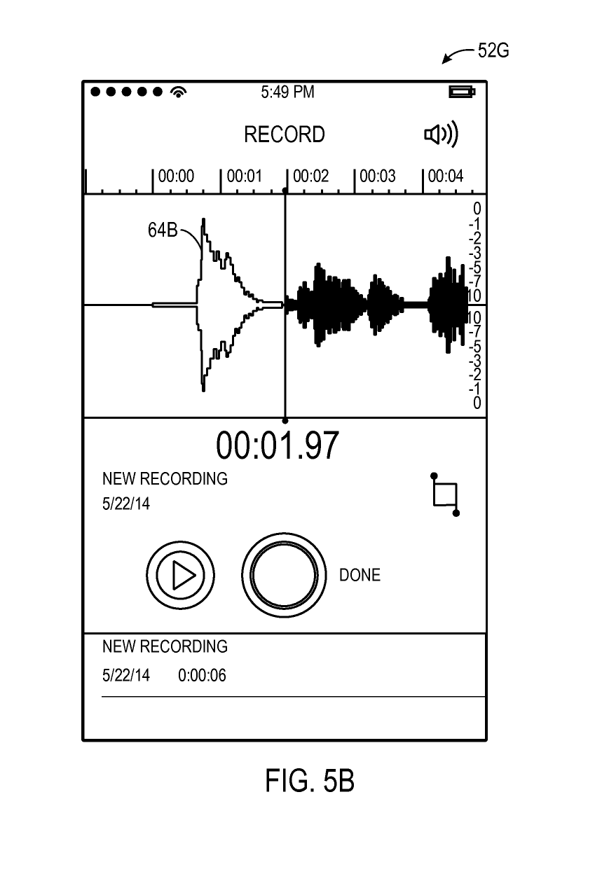

As described above, the handheld device 34 (e.g., computing device 10) may utilize a microphone 32 or 48 to capture surrounding sounds (e.g., audio), for example a user's voice (e.g., a voice memo) or a song. To facilitate recording audio, the computing device 10 may display a graphical user interface to present information to a user relating the audio recording. To help illustrate, a recording graphical user interface 52 is described in FIGS. 3A-5B. More specifically, as will be described in more detail below, FIGS. 3A-3C describe the recording of an original piece of audio, FIGS. 4A and 4B describe overwriting (e.g., re-recording) a portion of the original piece of audio, and FIGS. 5A and 5B describe replacing (e.g., re-recording) a portion of the original piece of audio.

As described above, FIGS. 3A-3C describe the recording graphical user interface 52 displayed when an original piece of audio is recorded. More specifically, the graphical user interface 52A depicted in FIG. 3A may be presented when an audio recording process in initiated. In some embodiments, the audio recording process may be initiated, for example, by launching an application, such as Voice Memo from Apple Inc., on the computing device 10. In other words, the graphical user interface 52A may be referred to as an audio recording home screen 52A.

In some embodiments, the audio recording home screen 52A may provide a list 54 of previously recorded pieces of audio. For example, in the depicted embodiment, the recording home screen 52A indicates that an audio recording entitled “New Recording” was made on May 22, 2014 and has a duration of nine seconds. In some embodiments, a user may select a previous recording from the list, for example by clicking on the desired audio recording, to play back the selected audio and/or perform edit operations on the selected audio. Additionally, the audio recording home screen 52A may enable a new audio recording to be created. For example, in the depicted embodiment, a user may instruct the computing device 10 to create a new audio recording by selecting the record button 56.

Once the record button 56 is selected, the computing device 10 may begin recording sound surrounding the microphone 32 or 48. For example, to record the audio, the microphone 32 or 48 may record surrounding sound (e.g., audio) by creating an analog representation of the sound. Additionally, the computing device 10 may process the recorded audio, for example, to store the recorded audio and/or to enable editing the recorded audio. For instance, in some embodiments, the processor 12 may convert the analog representation into a digital representation and the processor 12 may store the digital representation of the recorded audio in memory 14 or non-voltage storage 16.

Additionally, to facilitate recording the audio, the computing device 10, and more specifically the processor 12, may process the recorded audio to present information related to the recorded audio on the graphical user interface 52B as described in FIG. 3B. For example, in the depicted embodiment, the graphical user interface 52B includes an audio timeline 58, a playback cursor 60, a cursor time indicator 62, a waveform 64, a title indicator 66, and a date indicator 68.

More specifically, the cursor time indicator 62 may indicate where in the recorded audio the playback cursor 60 is located. For example, in the depicted embodiment, the cursor indicator 62 indicates that the playback cursor 60 is located at 8.52 seconds. Additionally, the waveform 64 indicates the intensity (e.g., volume) of the recorded audio. For example, in some embodiments, the louder the recorded audio the larger the amplitude of the waveform 64. Furthermore, the audio timeline 58 describes a time range for which the waveform 64 is depicted and in which the playback cursor 60 is located. In addition, the title indicator 66 may indicate the title of the recorded audio and the date indicator 68 may indicate when the audio was or is being recorded. For example, in the depicted embodiment, the title of the audio recording is “New Recording 2” and is being recorded on May 22, 2014.

As will be described in more detail below, an original piece of audio may be recorded by creating an original audio composition. In some embodiments, the original audio composition may include an audio file reference to an audio file, which is a digital representation of the original piece of audio, a waveform file reference to a waveform file, which stores a digital representation of intensity of the original piece of audio data, and metadata, which may describe playback organization, enable recomposition into a composed audio composition, and enable generating a finalized audio file and/or a finalized waveform file.

The computing device 10 may continue recording audio and generating the original audio composition until paused by selecting the record button 56. Additionally, the computing device 10 may resume recording audio once the recording button is again selected. To help illustrate, the computing device 10 may record 8.52 seconds of audio, pause for some duration, and resume recording audio for another 4.18 second. Accordingly, as indicated in FIG. 3B, the computing device 10 records a first portion of audio from 0 second to 8.52 seconds. Additionally, as indicated in FIG. 3C, the computing device 10 resumes recording and records a second portion of audio from 8.52 second to 12.70 seconds.

As such, when the computing device 10 pauses and resumes recording, portions of audio recorded after resuming may be appended on previously recorded portions. In some embodiments, to append the subsequently recorded portions of audio, the original audio composition may be modified. For example, the source time range and/or destination time range may be increased. Additionally, the audio file referenced in the original audio composition may be modified by appending a digital representation of the subsequently recorded audio onto a digital presentation of the previously recorded audio. Similarly, the waveform file referenced in the original audio composition may be modified by appending a digital representation of the intensity of the subsequently recorded audio onto a digital representation of the intensity of the previously recorded audio.

In other words, when subsequently recorded audio is appended on previously recorded audio, the previously recorded audio is not modified. However, in other instances, subsequently recorded audio may be used to modify (e.g., re-record) portions of the previously recorded audio. For example, in some embodiments, subsequently recorded audio may be recorded to overwrite portions of previously recorded audio. In some embodiments, portions of previously recorded audio may be overwritten by moving the playback cursor 60 along the audio timeline 58 to a time during the recorded audio, as described in FIG. 4A. For example, as depicted, the playback cursor 60 is moved to 2.04 seconds.

Once the playback cursor 60 is moved, a portion of previously recorded audio may be overwritten by hitting the record button 56. To help illustrate, a subsequent piece of audio with a duration of 9.01 seconds may be recorded. Accordingly, as indicated in FIG. 4B, the portion of the previously recorded audio between 2.04 seconds and 11.05 seconds may be overwritten with the subsequently recorded audio. As such, when the recorded audio is played back, the previously recorded audio will play from 0 seconds to 2.04 seconds, the subsequently recorded audio will play from 2.04 second to 11.05 seconds, and the previously recorded audio will play from 11.05 second to 12.70 seconds.

In some embodiments, overwriting the previously recorded audio may be represented by the graphical user interface 52E by replacing the waveform 64A for the previously recorded audio with a waveform 64B for the subsequently recorded audio. In fact, in some embodiments, the waveform 64B for the subsequently recorded audio may be a different color, such as red, to indicate that portions of the previously recorded audio are being modified.

Additionally, portions of previously recorded audio may be modified by replacing a selected portion of the previously recorded audio with subsequently recorded audio. In some embodiments, a portion of the previously recorded audio may be selected by selecting the selection mode icon 70. Once the selection mode icon 70 is selected, selection cursors 72 may be displayed, as depicted in FIG. 5A. More specifically, the selection cursors 72 may be moved along the audio timeline 58 to select a portion of recorded audio between the two selection cursors 72 (indicated by dashed waveform). For example, in the depicted embodiment, the portion of the recorded audio between 0 seconds and 2.67 seconds is selected by the selction cursors 72.

Once the portion of the recorded audio is selected, various operations may be performed. For example, the selection of a cancel button 72 may cancel the selection and exit selection mode, selection of a delete button 74 may delete the selected portion of the recorded audio, and the selection of a trim button 76 may delete the portion of the recorded audio that is not selected. As will be described in more detail below, the use of metadata in the original audio composition and any audio fragments may improve the efficiency of the delete and/or trim operations. More specifically, a trim or a delete operation may be performed merely by adjusting the metadata, which describes playback organization of an original audio composition and any audio fragments and/or how to piece together an original audio composition and any audio fragments into a composed audio composition.

Additionally, the record button 56 may be selected to replace the selected portion of the previously recorded audio with subsequently recorded audio. To help illustrate, FIG. 5B depicts that the selected portion of the previously recorded audio is replaced by subsequently recorded audio. More specifically, as depicted, the selected portion of the previously recorded audio between 0 seconds and 2.67 seconds is replaced with subsequently recorded audio 1.97 second in length. The unselected portion of the previously recorded audio are appended to either side of the subsequently recorded audio. It is noted that in the depicted embodiment, since the selected portion begins at 0 seconds, the previously recorded audio is not appended in front. As such, assuming that the previously recorded audio is 12.7 second in length, during play back of the recorded audio, the subsequently recorded audio will play from 0 seconds to 1.97 seconds and the previously recorded audio will play from 1.97 seconds to 12 seconds.

In some embodiments, replacing portions of the previously recorded audio may be represented by the graphical user interface 52E by replacing the waveform 64C for the selected portion with a waveform 64B for the subsequently recorded audio. In fact, in some embodiments, the waveform 64B for the subsequently recorded audio may be a different color, such as red, to indicate that portions of the previously recorded audio are being modified.

Thus, when subsequently recorded audio overwrites or replaces previously recorded audio, the previously recorded audio may be adjusted. In some embodiments, similar to appending subsequently recorded audio, the original audio composition may be modified. For example, the audio file may be modified by replacing a portion of the digital representation of the previously recorded audio with a digital representation of the subsequently recorded audio. Similarly, the waveform file may be modified by replacing a portion of the digital representation of the intensity of the previously recorded audio with a digital representation of the intensity of the subsequently recorded audio.

However, as described above, modifying the audio file and/or the waveform file when portions of the previously recorded audio are modified may be relatively time consuming. Additionally, the time used to modify the audio file and/or the waveform file may increase noticeably with the length of the recording.

As such, techniques described herein may improve the efficiency of modifying portions of the previously recorded audio by using an original audio composition and audio fragments. Generally, an audio fragment includes the same components (e.g., audio file reference, waveform file reference, source time range, destination time range, or any combination thereof) as the original audio composition. However, the use of audio fragments to describe the subsequently recorded audio is intended to differentiate the previously recorded audio and the subsequently recorded audio.

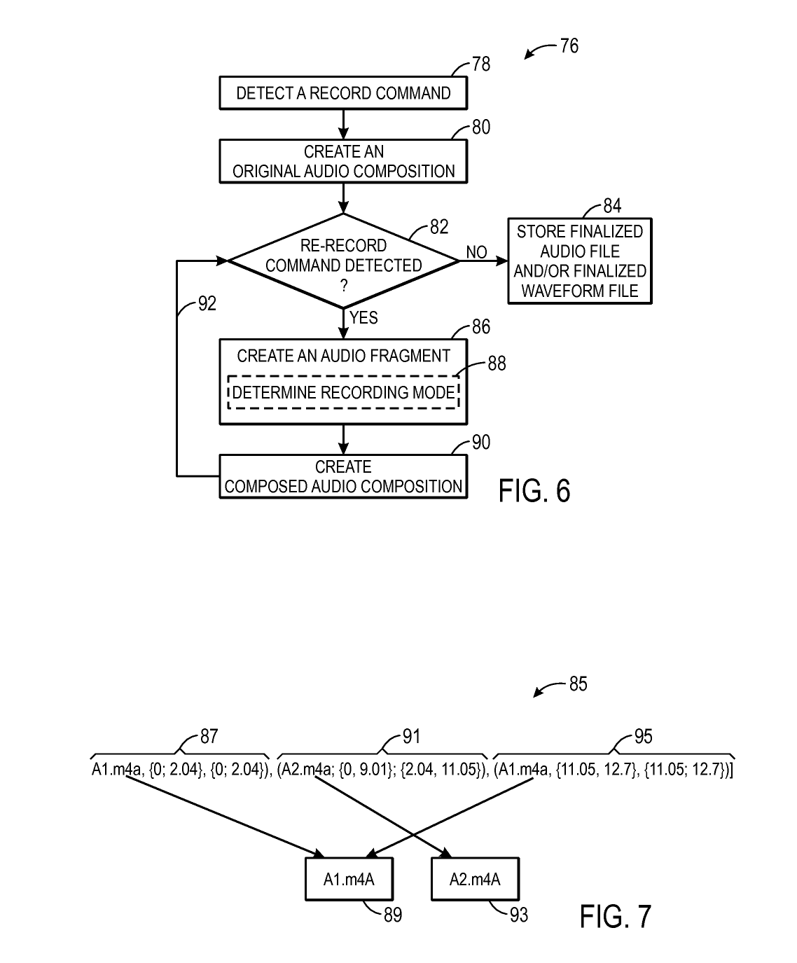

More specifically, an audio fragment may be generated when a portion of previously recorded audio is re-recorded (e.g., modified). To help illustrate, a process 76 for re-recording at least a portion of previously recorded audio is described in FIG. 6. Generally, the process 76 includes detecting a record command (process block 78), creating an original audio composition (process block 80), determining whether a re-record command is detected (decision block 82), and if a re-record command is not detected storing a finalized audio file and/or waveform file (process block 84). On the other hand, if a re-record command is detected, the process 76 includes creating an audio fragment (process block 86), optionally determining the recording mode (process block 88), and creating a composed audio fragment (process block 90). In some embodiments, process 76 may be implemented by executable instructions stored in memory 14, non-volatile storage 16, or another tangible, non-transitory, computer readable medium executable by processor 12 or another processing circuitry.

Accordingly, the computing device 10 may detect a record command instructing the computing device 10 to capture a fist (e.g., original) piece of audio (process block 78). In some embodiments, the record command may be received when a user selects the record button 56 from the audio recording home screen 52A. Once the record command is received, the computing device may begin creating an original audio composition (process block 80). As described above, in some embodiments, the original audio composition may include an audio file reference, a waveform file reference, metadata, or any combination thereof.

Thus, the computing device 10 may generate an audio file, which stores a digital representation of the first piece of audio. In some embodiments, to generate the audio file, the processor 12 may instruct the microphone 32 or 48 to capture an analog representation (e.g., signal) of surrounding sound. Then, the processor 12 may convert the analog representation into a digital representation of the surrounding sound. In some embodiments, the digital representation may be stored in memory 14 or non-volatile storage 16 as a file (e.g., audio file) and referenced by the audio file reference in the original audio composition.

Additionally, the computing device 10 may generate a waveform file, which stores a digital representation of the intensity of the first piece of audio. In some embodiments, to generate the waveform file, the processor 12 may determine the intensity (e.g., volume) of the recorded audio based on the analog representation of the recorded audio and/or the digital representation of the recorded audio. For example, the processor 12 may look at the amplitude of the analog representation of the recorded audio to determine intensity and generate a digital representation of the intensity. Additionally, in some embodiments, the digital representation of intensity may be stored in memory 14 or non-volatile storage 16 as a file (e.g., a waveform file) and referenced by the waveform file reference in the original audio composition.

Furthermore, the computing device 10 may generate metadata included in the original audio composition. Generally, the metadata describes how the original audio composition relates to other pieces of recorded audio (e.g., audio fragments). Accordingly, in some embodiments, the metadata may include a source time range and/or a destination time range. More specifically, the source time range may describe what portion of the corresponding (e.g., referenced) audio file to use in playback and a destination time range may describe when to play the portion of the corresponding (e.g., referenced) audio file during playback. In other words, the metadata in the original audio composition is distinct from any metadata that may be included in the audio file and/or waveform file.

Accordingly, to create the original audio composition, the computing device 10 may link or combine the audio file, the waveform file, metadata, or any combination thereof. To help illustrate, the original audio composition may be an array and takes the following form:

[(audio file reference; waveform file reference; source time range; destination time range)]

In other embodiments, the original audio composition may be an array that takes the following form:

[(audio file reference; source time range reference; destination time range)]

For example, when the first piece of audio is recorded in FIG. 3C, the original audio composition may be [(A1.m4a; {0, 12.70}; {0, 12.70})]. As such, the original audio composition indicates that the A1.m4a file stores a digital representation of the first piece of audio, the portion of the audio file to use during playback is seconds 0 to 12.70 of the recorded audio, and the portion should be played from 0 to 12.70 seconds during playback.

In some embodiments, the original audio composition may have been created in a previous recording session. As described above, previously recorded audio may be selected for playback/editing from the audio recording home screen 52A. In other words, the original audio composition may be created during a current recording session or a previous recording session.

After the original audio composition is created, the computing device 10 may determine if a re-record (e.g., overwrite or replace) command is detected (decision block 82). In some embodiments, a re-record command may be received when a user selects the record button 56 to modify at least a portion of the recorded audio. When a re-record command is not detected, the computing device 10 may store a finalized audio file and/or a finalized waveform file (process block 84). More specifically, in some embodiments, the processor 12 may store the finalized audio file and/or finalized waveform file referenced by the original audio composition by saving a digital copy in memory 14 or the non-volatile storage 16.

On the other hand, when a re-record command is detected, the computing device 10 may create an audio fragment (process block 86). Similar to the original audio composition, the audio fragment may include an audio file reference, a waveform file reference, metadata, or any combination thereof. In other words, the audio fragment may be generated in a similar manner as the original audio composition. More specifically, the computing device 10 may create an audio file, which stores a digital representation of a second piece of audio, a waveform file, which stores a digital representation of the intensity (e.g., volume) of the second piece of audio, and metadata that describes an organizational relationship with the original audio composition. In other words, the metadata in audio fragments is distinct from any metadata that may be included in the audio file and/or the waveform file. As used herein, an audio fragment is differentiated from the original audio composition because the audio fragment modifies at least a portion of recorded audio in the original audio composition or another audio fragment.

As described above, a re-record command may either overwrite a portion of recorded audio or to replace a selected portion of the recorded audio. As such, the effects on the original audio composition may differ for a second piece of audio that that overwrites and for a second piece of audio that replaces a selected portion. To help illustrate, when the second piece of audio is recorded to overwrite in FIG. 4B, the audio fragment may be [(A2.m4a; {0, 9.01}; {2.04, 11.05})]. On the other hand, when the second piece of audio is recorded to replace a portion of recorded audio in FIG. 5B, the audio fragment may be [(A2.m4a; {0, 1.97}; {0, 1.97})]. In other words, the audio file and/or the waveform file referenced may generally be the same, but the metadata (e.g., source time range and destination time range) may differ.

As such, to generate the audio fragment, the computing device 10 may optionally determine the recording mode (e.g., overwrite mode or replace mode) with which the second piece of audio is recorded (process block 88). More specifically, the computing device 10 may determine the recording mode based on the number and/or type of cursors 60 or 70 used. For example, the processor 12 may determine that the second piece of audio is recorded in overwrite mode when the playback cursor 60 is used. On the other hand, the processor 12 may determine that the second piece of audio is recorded in replace mode when the selection cursors 70 are used. In other words, the computing device 10 may determine the context with which recorded audio is modified (e.g., overwritten or replaced) based at least in part on the type and/or number of cursors.

In fact, the use of audio fragments may enable playback of the modified recorded audio even without modifying the audio file and/or waveform file in the original audio composition by creating a composed audio composition (process block 90). More specifically, the composed audio composition may be an array created based at least in part on the original audio composition and any audio fragments.

In some embodiments, the original audio composition and any fragment may be first used to generate a decomposed audio composition, which may then be used to generate a composed audio composition. More specifically, the decomposed audio composition may be generated by appending an audio fragment onto a previous audio composition. For example, when the second piece of audio is recorded in FIG. 4B to overwrite a portion of the recorded audio, the decomposed audio composition may be [(A1.m4a, {0; 12.70}, {0; 12.70}), (A2.m4a; {0, 9.01}; {2.04, 11.05})]. To further illustrate, when the second piece of audio is recorded in FIG. 5B to replace a selected portion of the recorded audio, the decomposed audio composition may be [(A1.m4a; {0, 12.70}; {0, 12.70}), (A2.m4a; {0, 1.97}; {0, 1.97})].

The composed audio composition may then be generated based on the decomposed audio composition. More specifically, the composed audio composition may be generated by propagating the effect of the new audio fragment on the previous audio composition. In other words, the computing device 10 may process the decomposed audio file from right to left. As such, the composed audio composition at FIG. 4B may be [(A1.m4a, {0; 2.04}, {0; 2.04}), (A2.m4a; {0, 9.01}; {2.04, 11.05}), (A1.m4a, {11.05, 12.7}, {11.05; 12.7})]

The computing device 10 may then use the composed audio composition to enable playback of recorded audio. To help illustrate, a block diagram 85 describes the playback of the above composed audio composition in FIG. 7. More specifically, in a first portion 87 of the composed audio composition, the audio file reference references the A1.m4a audio file 89, the source time range indicates that seconds 0 to 2.04 of the A1.m4a audio file 89 should be played, and the destination time range indicates that the portion indicated by the source time range should be played from 0 to 2.04 seconds during playback. Additionally, in a second portion 91 of the composed audio composition, the audio file reference references the A2.m4a audio file 93, the source time range indicates that seconds 0 to 9.01 of the A2.m4a 93 should be played, and the destination time range indicates that the portion indicated by the source time range should be played from 2.04 to 11.05 seconds during playback. Furthermore, in a third portion 95 of the composed audio composition, the audio file reference again references the A1.m4a audio file 89, the source time range indicates that seconds 11.05 to 12.7 of the A1.m4a audio file 89 should be played, and the destination time range indicates that the portion indicated by the source time range should be played from 11.05 to 12.70 seconds during playback.

To further illustrate, the composed audio composition that may be generated at FIG. 5B after a replace operation may be [(A2.m4a, {0, 1.97}; {0, 1.97}), (A1.m4a; {2.67, 12.70}; {0, 12})]. Accordingly, the destination time range of the audio fragment indicates that the recorded audio (e.g., first piece of audio) is replaced with the second piece of audio between 0 to 1.97 seconds. More specifically, based on the destination time ranges, the computing device 10 may determine that audio from the A2.m4a audio file should be played from 0 to 1.97 seconds and audio from the A1.m4a audio file should be played from 1.97 to 12 seconds. Additionally, based on the source time ranges, the computing device 10 may determine that seconds 0 to 1.97 seconds of the A2.m4a audio file should be played followed by seconds 2.67 to 12.70 of the A1.m4a audio file.

Once the composed audio composition is created, the computing device 10 may again (e.g., arrow 92) determine whether a re-record command is detected (decision block 82). In some embodiments, the computing device 10 may determine that a re-record command is detected when the record button 56 is selected. If a re-record command is detected, the computing device 10 may create another audio fragment (process block 86). To help illustrate, in a hypothetical scenario a first (e.g., original) piece of audio (e.g., A1) 12.70 seconds in length may be recorded and an original audio composition created. Subsequently, a second piece (e.g., A2) of audio 9.01 seconds in length may overwrite a portion of the recorded audio (e.g., first piece of audio) between 2.04 and 11.05 seconds. As described above, at this point, the composed audio composition may be [(A1.m4a, {0; 2.04}, {0; 2.04}), (A2.m4a; {0, 9.01}; {2.04, 11.05}), (A1.m4a, {11.05, 12.7}, {11.05; 12.7})].

Then, a third piece of audio (e.g., A3) 1.97 second in length may replace the portion of the recorded audio (e.g., combination of first and second pieces of audio) between 0 and 2.67 seconds. At this point, the decomposed audio composition may be [(A1.m4a, {0; 2.04}, {0; 2.04}), (A2.m4a; {0, 9.01}; {2.04, 11.05}), (A1.m4a, {11.05, 12.7}, {11.05; 12.7}), (A3.m4a, {0, 1.97}; {0, 2.67})]. As described above, the composed audio composition may then be generated by propagating the effects of the newly created audio fragment to the audio composition. More specifically, the effects may include replacing seconds 0 to 2.67 of the first piece of audio and replacing seconds 0 to 0.63 of the second piece of audio. Accordingly, the composed audio composition at this point may be [(A3.m4a; {0, 1.97}; {0, 1.97}), (A2.m4a; {0.63, 9.01}; {1.97, 10.35}), (A1.m4a; {11.05, 12.70}; {10.35, 12})].

Based on the destination time ranges, the computing device 10 may determine that audio from the A3.m4a audio file should be played during 0 to 1.97 seconds, audio from the A2.m4a audio file should be played from 1.97 to 10.35 seconds, and audio from the A1.m4a audio file should be played from 10.35 to 12 seconds. Additionally, based on the source time ranges, the computing device 10 may determine that seconds 0 to 1.97 of the A3.m4a audio file should be played, followed by seconds 0.63 to 9.01 of the A2.m4a audio file, and followed by seconds 11.05 to 12.70 of the A1.m4a audio file.

As illustrated by the above examples, re-recording to modify a portion of recorded audio may be performed even without modifying the audio file(s). More specifically, the recorded audio may be played backed using the composed audio compositions. One of ordinary skill in the will recognize that corresponding waveforms for the recorded audio may also be played back using similar techniques. For example, in some embodiments, a waveform for subsequently recorded audio may be displayed instead of a waveform for previously recorded audio even without modifying the waveform file(s). In other words, re-recording to modify a portion of recorded audio may be performed without modifying the waveform file(s).

However, to enable the recorded audio to be exported and played on other computing devices, the composed audio composition may be used to generate a finalized audio file and/or a finalized waveform file. Accordingly, if a re-record command is not detected (e.g., when a done button is selected), the computing device 10 may create and store a finalized audio file and/or waveform file (process block 84). In some embodiments, the finalized audio file and/or finalized waveform file may be created based at least in part on the composed audio composition (e.g., the original audio composition and any audio fragments).

More specifically, the finalized audio file may be generated by stitching together portions of the audio files referenced by the composed audio composition. For example, continuing again with the [(A1.m4a, {0; 2.04}, {0; 2.04}), (A2.m4a; {0, 9.01}; {2.04, 11.05}), (A1.m4a, {11.05, 12.7}, {11.05; 12.7})] composed audio composition, the computing device 10 may stitch together seconds 0 to 2.04 of the A1.m4a audio file with seconds 0 to 9.01 of the A1.m4a audio file and further with seconds 11.05 to 12.7 of the A1.m4a audio file to generate the finalized audio file. The corresponding waveform files referenced in the composed audio composition may be similarly stitched together to generate the finalized waveform file.

Thus, the audio file and/or the waveform files generated by each re-record operation are modified when the finalized audio file and/or finalized waveform file are created, but not after each re-record edit operation. As such, the efficiency of processing re-record edits on recorded audio may be improved by using an original audio composition and audio fragments. More specifically, as discussed above, the metadata (e.g., destination time range and source time range) may enable audio and/or waveform playback without modifying the actual audio and/or waveform files. Thus, the computing device 10 may maintain recorded audio as a combination of the original audio composition and any number of audio fragments (e.g., a composed audio composition) until the edits are finalized. By doing so, the number of times the audio files and/or waveform files are modified may be reduced, which may drastically improve efficiency for processing the edit operations.

Additionally, the use of audio fragments and metadata may provide other advantages, such as improving efficiency for processing trim/delete edits, enabling an undo command, and improving handling of an unexpected closure. To help illustrate, a process 94 for processing delete and/or a trim edit operations is described in FIG. 7. Generally, the process 94 includes detecting a selection mode (process block 96), detecting a trim/delete command (process block 98), and modifying metadata (process block 100). In some embodiments, process 94 may be implemented by executable instructions stored in memory 14, non-volatile storage 16, or another tangible, non-transitory, computer readable medium executable by processor 12 or another processing circuitry.

Accordingly, the computing device 10 may detect when it is in selection mode (process block 96). In some embodiments, the computing device 10 may enter a selection mode when a user selects a selection mode button 70. As described above, in the selection mode, selection cursors 70 are adjustable along the audio timeline 58 to select a portion of the recorded audio. For example, as depicted in FIG. 5A, the selection cursors 70 are adjusted to select seconds 0 to 2.67 of the recorded audio. Additionally, in the selection mode, various operations may be performed based on the selected portion of the recorded audio. For example, as described above, a user may cancel the selection, replace the selected portion, delete the selected portion, or delete the unselected portions (e.g., trim to selected portion).

Accordingly, the computing device 10 may detect when a trim or a delete command is received (process block 98). In some embodiments, the computing device 10 may receive a trim command when a user selects a trim button 76 and a delete command when the user selects a delete button 74. More specifically, the trim command instructs the computing device 10 to delete the unselected portions of the recorded audio. On the other hand, the delete command instructs the computing device 10 to delete the selected portion of the recorded audio.

Utilizing the techniques described herein, the computing device 10 may perform the trim or delete command by modifying the metadata (process block 100). To illustrate, an original piece of audio (A1), which is 10 seconds in length, may be recorded. Accordingly, the original audio composition may be [(A1.m4a; {0, 10}; {0, 10})]. Subsequently, a portion of the recorded audio from 3 to 6 seconds is selected. Thus, when a trim command is selected, the recorded audio will be modified such that the seconds 0 to 3 and seconds 6 to 10 are deleted. In some embodiments, this trim operation may be performed by modifying the original audio composition to [(A1.m4a; {3, 6}; {0, 3)]. On the other hand, when a delete command is selected, the recorded audio may be modified such that second 3 to 6 are deleted. In some embodiments, this delete operation may be performed by modifying the original audio composition to [(A1.m4a; {0, 3}; {0, 3}), (A1.m4a; {6, 10}; {3, 7})].

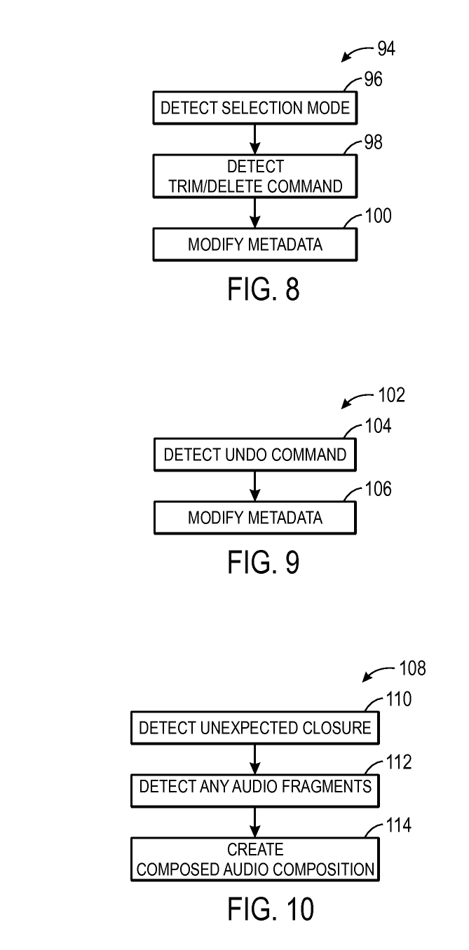

As such, the trim/delete edit operations as well as the re-record edit operations may be performed by editing the metadata included in the original audio composition and/or any audio fragments. In fact, in some embodiments, the edit operations may be performed even without modifying the audio file and/or the waveform file. As such, undoing an edit operation may be performed by undoing the adjustments to the metadata. To help illustrate, a process 102 for undoing edit operations is described in FIG. 8. Generally, the process 102 includes detecting an undo command 104 (process block 104) and modifying metadata (process block 106). In some embodiments, process 102 may be implemented by executable instructions stored in memory 14, non-volatile storage 16, or another tangible, non-transitory, computer readable medium executable by processor 12 or another processing circuitry.

Accordingly, the computing device 10 may detect when an undo command is received (process block 104). In some embodiments, an undo command may be received when a user selects an undo button. In other embodiments, an undo command may be received when a user shakes the phone. In such an embodiment, the processor 12 may detect an undo command when the accelerometer 30 indicates that the computing device 10 is being moved rapidly from left to right (e.g., shaken).

Once the undo command is received, the computing device 10 may undo the most recent edit operation by modifying metadata (process block 106). More specifically, the processor 12 may undo the changes to the metadata that was adjusted by the most recent edit operation and/or removing a newly generated audio fragment from the composed audio composition. For example, to undo the above described trim operation, the computing device may adjust the original audio composition from [(A1.m4a; {3, 6}; {0, 3)] back to [(A1.m4a; {0, 10}; {0, 10})].

In some embodiments, to facilitate undoing edit operations, a copy of the original audio composition and any audio fragments (e.g., as a decomposed or composed audio composition) may be pushed (e.g., stored) to a memory object in memory 14 or non-volatile storage 16 each time the recorded audio is edited. Accordingly, to undo an edit, the metadata in the original audio composition and any audio fragments may be reset to the most recently stored values in the memory object. For example, continuing again with the above described trim operation, when a trim command is detected, the computing device 10 may store the original audio composition, [(A1.m4a, {0, 10}; {0, 10}], in the memory object. When a subsequent edit operation is performed, the computing device may again store the audio composition, [(A1.m4a, ({3, 6}; {0, 3})], in the memory object. As such, the memory object may be a list (e.g., array) as follows [(A1.m4a, {0, 10}; {0, 10}], [(A1.m4a, ({3, 6}; {0, 3})].

Accordingly, the computing device 10 may undo the subsequent edit operation by resetting the audio composition back to one of the previous values stored in the memory object. For example, the processor 12 may undo the subsequent edit operation by retrieving the most recent audio composition from memory 14 and reset the audio composition to [(A1.m4a, ({3, 6}; {0, 3})]. Similarly, the processor 12 then undo the trim operation by retrieving the next most recent audio composition from memory 14 and reset the audio composition to [(A1.m4a, {0, 10}; {0, 10}].

In other words, the memory object (e.g., list) may easily enable undoing edit operations as well as redoing edit operations (without ever having to modify the underlying audio files) by retrieving stored audio compositions from memory 14 or non-volatile store 16. Additionally, in some embodiments, the memory object may enable the computing device 10 to keep track of the edit operations that have been performed because each edit operation will correspond with an entry in the memory object. In some embodiments, using the memory object, the computing device 10 may visually indicate to a user where various edit operations have been performed. For example, the waveform corresponding with each edited portion may be displayed as a different color.

Furthermore, the use of audio fragments and metadata may improve the handing of unexpected closures during audio recording. To help illustrate a process 108 for handing an unexpected closure is described in FIG. 9. Generally, the process 108 includes detecting an unexpected closure (process block 110), detecting any audio fragments (process block 112), and creating a composed audio composition (process block 114). In some embodiments, process 108 may be implemented by executable instructions stored in memory 14, non-volatile storage 16, or another tangible, non-transitory, computer readable medium executable by processor 12 or another processing circuitry.

Accordingly, in some embodiments, the computing device 10 may detect when an application used to record audio is unexpectedly closed (process block 110). In some embodiments, the application may unexpectedly close if the computing device 10 is low on memory. Thus, the processor 12 may determine that the audio recording is expectedly closed by looking at a diagnostic list for the computing device 10, which may include a list of recent crashes.

When an unexpected closure is detected, the computing device 10 may perform a search for any audio fragments (process block 112). In some embodiments, the processor 12 may search for audio fragments by polling memory 14 or non-volatile storage 16. More specifically, the processor 12 may determine that an audio fragment is present when the audio fragment modifies either an original audio composition or another audio fragment. In some embodiments, the presence of an audio fragment may indicate that the audio recording was incomplete at the time of the unexpected closure.

Accordingly, when an audio fragment is detected, the computing device 10 may automatically begin creating a composed audio composition (process block 114). More specifically, the composed audio composition may begin to be created because the presence of audio fragments indicates that an audio recording/editing process was being performed during the unexpected closure. In other words, the composed audio composition may begin to be created even before a user relaunches the application and, in fact, may be ready for playback and/or further editing as soon as the application is relaunched. Additionally, in some embodiments, the computing device 10 may begin creating finalized audio files and/or finalized waveform files.

Accordingly, the technical effects of the present disclosure include improving an audio recording process by improving the efficiency edits to recorded audio are being processed. More specifically, edits to recorded audio may be processed by creating an original audio composition when an original piece of audio is recorded and an audio fragment may be created each time a subsequently recorded piece of audio modifies the previously recorded audio (e.g., original audio composition and/or other audio fragments). In some embodiments, the original audio composition and any audio fragments may each include an audio file reference to an audio file, which stores a digital representation of recorded audio, a waveform file reference to a waveform file, which stores a digital representation of intensity of the recorded audio, metadata (e.g., source time range and destination time range), which describes playback organization relationships, or any combination thereof. As such, edit operations to recorded audio may be performed by adjusting the metadata or creating an audio fragment that modifies the recorded audio (e.g., original audio composition and/or other audio fragments). In other words, the number of times existing audio files and/or waveform files are modified in an audio editing process may be reduced, which greatly improves the efficiency for processing edit operations. The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A tangible, non-transitory, computer readable medium storing instructions executable by a processor of a computing device configured to record audio, wherein the instructions comprise instructions to:
when a first record command to record a first piece of audio is detected, generate, using the processor, an original audio composition comprising a first audio file reference to a first audio file that stores a digital representation of the first piece of audio, a first waveform file reference to a first waveform file that stores a digital representation of intensity of the first piece of audio, and a first metadata; and
when a second record command that modifies at least a portion of the first piece of audio is detected, generate, using the processor, an audio fragment comprising a second audio file reference to a second audio file that stores a digital representation of the second piece of audio, a second waveform file reference to a second waveform file that stores a digital representation of intensity of the second piece of audio, and a second metadata,
wherein the first metadata and second metadata are configured to describe playback organization of the first audio file, the second audio file, the first waveform file, and the second waveform file, and to enable recomposition of the original audio composition and the audio fragment into a composed audio composition.

2. The tangible, non-transitory, computer readable medium of claim 1, wherein the first metadata comprises a first source time range and a first destination time range, wherein the first source time range describes a portion of the first audio file to use in playback and the first destination time range describes when the portion of the first audio file should be played during playback.

3. The tangible, non-transitory, computer readable medium of claim 2, wherein the second metadata comprises a second source time range and a second destination time range, wherein the second source time range describes a portion of the second audio file to use in playback and the second destination time range describes when the portion of the second audio file should be played in relation to the portion of the first audio file.

4. The tangible, non-transitory, computer readable medium of claim 1, wherein the first metadata and the second metadata are configured to enable generation of a finalized audio file when a done command is detected, wherein generating the finalized audio file comprises combining the first audio file and the second audio file.

5. The tangible, non-transitory, computer readable medium of claim 1, wherein generating the audio fragment does not modify the first audio file or the first waveform file.

6. The tangible, non-transitory computer readable medium of claim 1, wherein the instructions comprise instructions to generate another audio fragment when a third record command that modifies a portion of the first piece of audio or a portion of the second piece of audio is detected.

7. A computing device, comprising:
a speaker configured to play audio;
a microphone configured to generate a first analog representation of a first piece of audio proximate to the microphone and to generate a second analog representation of a second piece of audio proximate to the microphone; and
a processor configured to:
record the first piece of audio by converting the first analog representation into a first digital representation of the first piece of audio and generating an original audio composition that references the first digital representation,
record the second piece of audio by converting the second analog representation into a second digital representation of the second piece of audio and generating an audio fragment that references the second digital representation, wherein the audio fragment is generated such that the second piece of audio modifies at least a first portion of the first piece of audio during playback, and
instruct the speaker to playback recorded audio based at least in part on the original audio composition and the audio fragment such that the played audio comprise a second portion of the first piece of audio and at least a portion of the second piece of audio.

8. The computing device of claim 7, comprising a display configured to display a single waveform that represents intensity of the recorded audio based at least in part on the original audio composition and the audio fragment, wherein the original audio composition comprises a digital representation of intensity of the first piece of audio and the audio fragment comprises a digital representation of intensity of the second piece of audio.

9. The computing device of claim 7, wherein the processor is configured to generate a composed audio composition based at least in part on the original audio composition and the audio fragment and to generate a finalized audio file based at least in part on the composed audio composition

10. The computing device of claim 7, wherein the computing device is a handheld device.

11. A method comprising:
determining, using a processor in a computing device that records audio, a record command to re-record a portion of previously recorded audio with a subsequently recorded piece of audio;
determining, using the processor, a record mode based on number or type of cursors used when the re-record is initiated, wherein an overwrite mode is determined when a playback cursor is used and a replace mode is determined when selection cursors are used;
when an overwrite mode is detected, overwrite a portion of the previously recorded audio starting at the playback cursor with the subsequently recorded piece of audio; and
when a replace mode is detected, replace a portion of the previously recorded audio identified by the selection cursors with the subsequently recorded piece of audio.

12. The method of claim 11, wherein overwriting or replacing the portion of the previously recorded audio comprises displaying a waveform representing intensity of the subsequently recorded audio in place of a portion of a waveform representing intensity of the previously recorded audio.

13. The method of claim 12, wherein the waveform representing intensity of the subsequently recorded audio is displayed as a different color than the waveform representing intensity of the previously recorded audio to indicate that the previously recorded audio is being modified.

14. The method of claim 11, wherein the playback cursor is a single cursor and the selection cursors are two cursors.

15. The method of claim 11, wherein the selection cursors are used when a selection mode icon is selected.

16. A processor in a computing device configured to play back recorded audio, wherein the processor is configured to play back recorded audio based at least in part on a composed audio composition, wherein the composed audio composition comprises:
an original audio composition comprising a first audio file reference to a first audio file that stores a digital representation of a first piece of audio, a first source time range that describes a portion of the first audio file to play, and a first destination time range that describes when to play the portion of the first audio file; and
an audio fragment comprising a second audio file reference to a second audio file that stores a digital representation of a second piece of audio, a second source time range that describes a portion of the second audio file to play, and a second destination time range that describes when to play the portion of the second audio file in relation to the portion of the first audio file.

17. The processor of claim 16, wherein the processor is configured to play back recorded audio by instructing a speaker communicatively coupled to the processor to:
play the portion of the second audio file indicated by the second source time range at a time during playback indicated by the second destination time range; and
play the portion of the first audio file indicated by the first source time range when the second audio file is not being played.

18. The processor of claim 16, wherein processor is configured to generate the composed audio composition by combining the original audio composition, the audio fragment, and any other subsequently generated audio fragments into an array.

19. The processor of claim 16, wherein the composed audio composition is generated based at least in part on a decomposed audio composition, wherein the decomposed audio composition is an array that stores the original audio composition as a first entry and the audio fragment as a second entry right of the first entry, wherein each entry in the decomposed audio composition modifies entries to its left.

20. The processor of claim 16, wherein the processor is configured to generate a finalized audio file based at least in part on the composed audio composition by stitching together a portion of the first audio file and at least a portion of the second audio file.

21. A method comprising:
detecting, using a processor in a computing device that records audio, an unexpected closure of an application used to edit recorded audio;
detecting, using the processor, whether an audio fragment is present after the unexpected closure of the application; and
when an audio fragment is detected, automatically generating, using the processor, a composed audio composition based at least in part on the audio fragment and any audio compositions.

22. The method of claim 21, wherein the composed audio composition begins generating before the application is relaunched.

23. The method of claim 21, wherein the composed audio composition is available to play back or edit as soon as the application is relaunched.

24. The method of claim 21, wherein detecting whether the audio fragment is present comprises polling memory in the computing device to locate any audio fragments that modify another audio fragment or an audio composition.

25. The method of claim 21, wherein presence of the audio fragment indicates that an audio editing process was incomplete when the application unexpectedly closed.

26. The method of claim 21, comprising generating a finalized audio file based at least in part on the composed audio composition.
